(19) United States
(12) Patent Application Publication
(10) Pub. No.: US 2018/0278438 A1
(43) Pub. Date: Sep. 27, 2018

(54) CHANNEL ESTIMATION METHOD IN DUAL MOBILITY ENVIRONMENT, AND USER EQUIPMENT

(71) Applicant: LG ELECTRONICS INC., Seoul (KR)

(72) Inventors: Manyoung JUNG, Seoul (KR); Yoonoh YANG, Seoul (KR); Sangwook LEE, Seoul (KR); Suhwan LIM, Seoul (KR); Jinyup HWANG, Seoul (KR)

(73) Assignee: LG ELECTRONICS INC., Seoul (KR)

(21) Appl. No.: 15/760,614

(22) PCT Filed: Sep. 19, 2016
(86) PCT No.: PCT/KR2016/010401

§ 371 Date: Mar. 15, 2018

Related U.S. Application Data
(60) Provisional application No. 62/220,255, filed on Sep. 18, 2015.

(51) Int. Cl. H04L 25/02; H04B 7/06

(52) U.S. Cl. CPC H04L 25/0224; H04B 7/0613

(57) ABSTRACT

A disclosed feature of the present specification provides a method for user equipment estimating a channel. The method may comprise the steps of: receiving two or more cell-specific reference signals (CRSs); dividing the two or more CRSs into two groups depending on an antenna port number; executing Doppler frequency tracking with respect to the respective divided groups; and estimating a single frequency network (SFN) channel based on the result of Doppler frequency tracking executed for the respective groups.

### BACKGROUND OF THE INVENTION

### Field of the Invention

The present invention relates to mobile communication.

### Related Art

3rd generation partnership project (3GPP) long term evolution (LTE) evolved from a universal mobile telecommunications system (UMTS) is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas.

As disclosed in 3GPP TS 36.211 V10.4.0 (2011-12) “Evolved Universal Terrestrial Radio Access (E-UTRA); Physical Channels and Modulation (Release 10)”, a physical channel of LTE may be classified into a downlink channel, i.e., a Physical Downlink Shared Channel (PDSCH) and a Physical Downlink Control Channel (PDCCH), and an uplink channel, i.e., a Physical Uplink Shared Channel (PUSCH) and a Physical Uplink Control Channel (PUCCH).

Meanwhile, the adoption of express trains has been increasing globally at a vast rate. And, accordingly, the need for high-speed data communication in a high-speed travelling environment is also increasing. In the following description, a case where a mobile wireless device is positioned in a means of transportation will be referred to as a dual mobility environment.

However, the current LTE or LTE-Advanced (LTE-A) standard lacks the definition of an environment moving (or travelling) at a high speed (or a high-speed travelling environment). Most particularly, according to the current LTE or LTE-A standard, in a high-speed travelling environment, the estimation of a Single Frequency Network (SFN) channel acts as the main cause of performance degradation. Therefore, a solution that allows the estimation of an SFN channel to be effectively performed in a dual mobility environment is required.

### SUMMARY OF THE INVENTION

Accordingly, an object of a disclosure of this specification is to provide a method for effectively performing channel estimation in a dual mobility environment.

And, an object of another disclosure of this specification is to provide a user equipment that can effectively perform channel estimation in a dual mobility environment.

In order to achieve the above-described objects, a disclosure of this specification provides a method for estimating a channel by a user equipment (UE). The method may include the steps of receiving two or more Cell-specific Reference Signals (CRSs), dividing the two or more CRSs into two different groups based on antenna port numbers, performing doppler frequency tracking for each of the divided groups, and estimating a Single Frequency Network (SFN) channel based on a result of the doppler frequency tracking performed for each of the divided groups.

In the step of dividing the two or more CRSs into two different groups, the two or more CRSs may be divided into an odd-numbered group and an even-numbered group, wherein CRSs having odd-numbered antenna port numbers may be grouped to the odd-numbered group and CRSs having even-numbered antenna port numbers may be grouped to the even-numbered group. Most particularly, the CRSs being divided into the odd-numbered group and the even-numbered group may be each received through a different Remote Radio Head (RRH).

In the step of dividing the two or more CRSs into two different groups, the two or more CRSs may be divided into two different groups, only when an indicator for notifying that communication is being performed by using the SFN channel is received. At this point, the indicator may be extracted from a Master Information Block (MIB) being received through a Physical Broadcast Channel (PBCH). And, most particularly, the indicator may be transmitted through 1 bit being replaced for transmitting the indicator, among spare bits included in the MIB.

Additionally, the method may further include a step of performing automatic frequency control based on a weighted-average value for the SFN channel estimation result.

In order to achieve the above-described objects, another disclosure of this specification provides a user equipment (UE) for estimating a channel. The user equipment may include a radio frequency (RF) unit transmitting and receiving radio signals, and a processor controlling the RF unit. The processor may control the RF unit so as to receive two or more Cell-specific Reference Signals (CRSs), to divide the two or more CRSs into two different groups based on antenna port numbers, to perform doppler frequency tracking for each of the divided groups, and to estimate a Single Frequency Network (SFN) channel based on a result of the doppler frequency tracking performed for each of the divided groups.

### Effects of the Invention

According to the disclosure of this specification, performance degradation in SFN channel estimation may be prevented by performing effective dual frequency tracking in a dual mobility environment.

### BRIEF DESCRIPTION OF THE DRAWINGS

FIG. 1 illustrates a wireless communication system.

FIG. 2 illustrates the structure of a radio frame according to FDD (frequency division duplex) in 3GPP LTE.

FIG. 3 illustrates an example resource grid for one uplink or downlink slot in 3GPP LTE.

FIG. 4 illustrates the architecture of a downlink sub-frame in 3GPP LTE.

FIG. 5 illustrates the architecture of an uplink sub-frame in 3GPP LTE.

FIG. 6 to FIG. 8 respectively illustrate examples of Cell-specific Reference Signal (CRS) structures in case one or more antennas are used.

FIG. 9 and FIG. 10 respectively illustrate examples of Dedicated RS (DRS) structures.

FIG. 11 illustrates an example of a DeModulation RS (DMRS) structure.

FIG. 12 illustrates an example of a dual mobility environment.

FIG. 13a to FIG. 13c respectively illustrate simulation results indicating channel characteristics of two Doppler frequencies.

FIG. 14a and FIG. 14b respectively illustrate simulation results indicating channel estimating performance in a dual mobility environment.

FIG. 15 conceptually illustrates a channel estimation method according to this specification.

FIG. 16 illustrates an exemplary structure of a related art CRS channel estimator.

FIG. 17 illustrates an exemplary structure of a CRS channel estimator according to this specification.

FIG. 18 is a flow chart showing a channel estimation method according to this specification.

FIG. 19 is a block diagram illustrating a wireless communication system according to an embodiment of the present invention.

### DESCRIPTION OF EXEMPLARY EMBODIMENTS

The technical terms used herein are used to merely describe specific embodiments and should not be construed as limiting the present invention. Further, the technical terms used herein should be, unless defined otherwise, interpreted as having meanings generally understood by those skilled in the art but not too broadly or too narrowly. Further, the technical terms used herein, which are determined not to exactly represent the spirit of the invention, should be replaced by or understood by such technical terms as being able to be exactly understood by those skilled in the art. Further, the general terms used herein should be interpreted in the context as defined in the dictionary, but not in an excessively narrowed manner.

The expression of the singular number in the specification includes the meaning of the plural number unless the meaning of the singular number is definitely different from that of the plural number in the context. In the following description, the term ‘include’ or ‘have’ may represent the existence of a feature, a number, a step, an operation, a component, a part or the combination thereof described in the specification, and may not exclude the existence or addition of another feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without deviating from the scope of the present invention.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the present invention will be described in greater detail with reference to the accompanying drawings. In describing the present invention, for ease of understanding, the same reference numerals are used to denote the same components throughout the drawings, and repetitive description on the same components will be omitted. Detailed description on well-known arts which are determined to make the gist of the invention unclear will be omitted. The accompanying drawings are provided to merely make the spirit of the invention readily understood, but not should be intended to be limiting of the invention. It should be understood that the spirit of the invention may be expanded to its modifications, replacements or equivalents in addition to what is shown in the drawings.

As used herein, ‘wireless device’ may be stationary or mobile, and may be denoted by other terms such as terminal, mobile terminal (MT), user equipment (UE), mobile equipment (ME), mobile station (MS), user terminal (UT), subscriber station (SS), handheld device, or access terminal (AT).

As used herein, ‘base station’ generally refers to a fixed station that communicates with a wireless device and may be denoted by other terms such as evolved-NodeB (eNB), base transceiver system (BTS), or access point.

Hereinafter, applications of the present invention based on 3rd generation partnership project (3GPP) long term evolution (LTE) or 3GPP LTE-advanced (LTE-A) are described. However, this is merely an example, and the present invention may apply to various wireless communication systems. Hereinafter, LTE includes LTE and/or LTE-A.

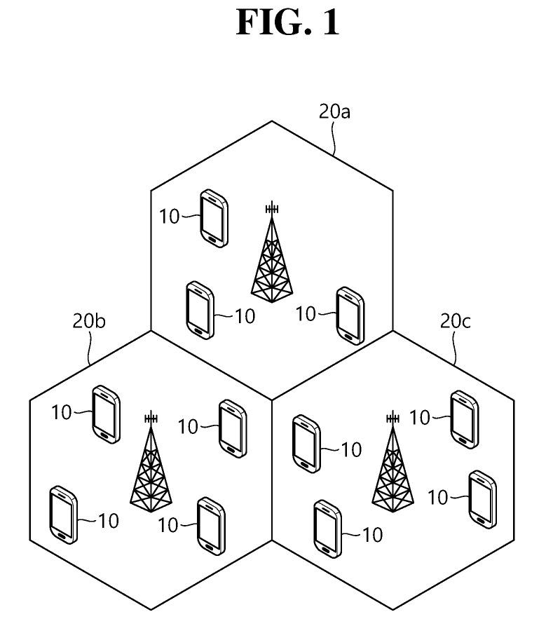

FIG. 1 illustrates a wireless communication system.

As seen with reference to FIG. 1, the wireless communication system includes at least one base station (BS) 20. Each base station 20 provides a communication service to specific geographical areas (generally, referred to as cells) 20a, 20b, and 20c.

The UE generally belongs to one cell and the cell to which the UE belong is referred to as a serving cell. A base station that provides the communication service to the serving cell is referred to as a serving BS. Since the wireless communication system is a cellular system, another cell that neighbors to the serving cell is present. Another cell which neighbors to the serving cell is referred to a neighbor cell. A base station that provides the communication service to the neighbor cell is referred to as a neighbor BS. The serving cell and the neighbor cell are relatively decided based on the UE.

Hereinafter, a downlink means communication from the base station 20 to the UE 10 and an uplink means communication from the UE 10 to the base station 20. In the downlink, a transmitter may be a part of the base station 20 and a receiver may be a part of the UE 10. In the uplink, the transmitter may be a part of the UE 10 and the receiver may be a part of the base station 20.

Hereinafter, the LTE system will be described in detail.

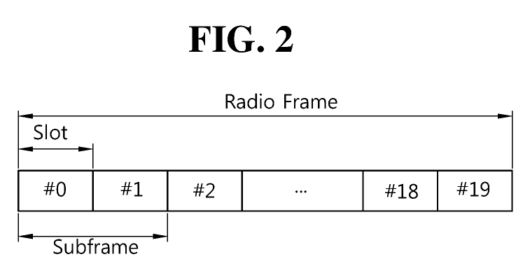

FIG. 2 illustrates the structure of a radio frame according to frequency division duplex (FDD) in 3GPP LTE.

For the radio frame shown in FIG. 2, 3rd Generation Partnership Project (3GPP) TS 36.211 V8.2.0 (2008-03) “Technical Specification Group Radio Access Network; Evolved Universal Terrestrial Radio Access (E-UTRA); Physical channels and modulation (Release 8)”, Ch. 5 may be referenced.

Referring to FIG. 2, a radio frame includes 10 sub-frames, and one sub-frame includes two slots. The slots in the radio frame are marked with slot numbers 0 through 19. The time taken for one sub-frame to be transmitted is referred to as a transmission time interval (TTI). The TTI may be the unit of scheduling for data transmission. For example, the length of one radio frame may be 10 ms, the length of one sub-frame may be 1 ms, and the length of one slot may be 0.5 ms.

The structure of a radio frame is merely an example, and the number of sub-frames included in the radio frame or the number of slots included in a sub-frame may vary differently.

Meanwhile, one slot may include a plurality of OFDM symbols. How many OFDM symbols are included in one slot may vary depending on cyclic prefix (CP).

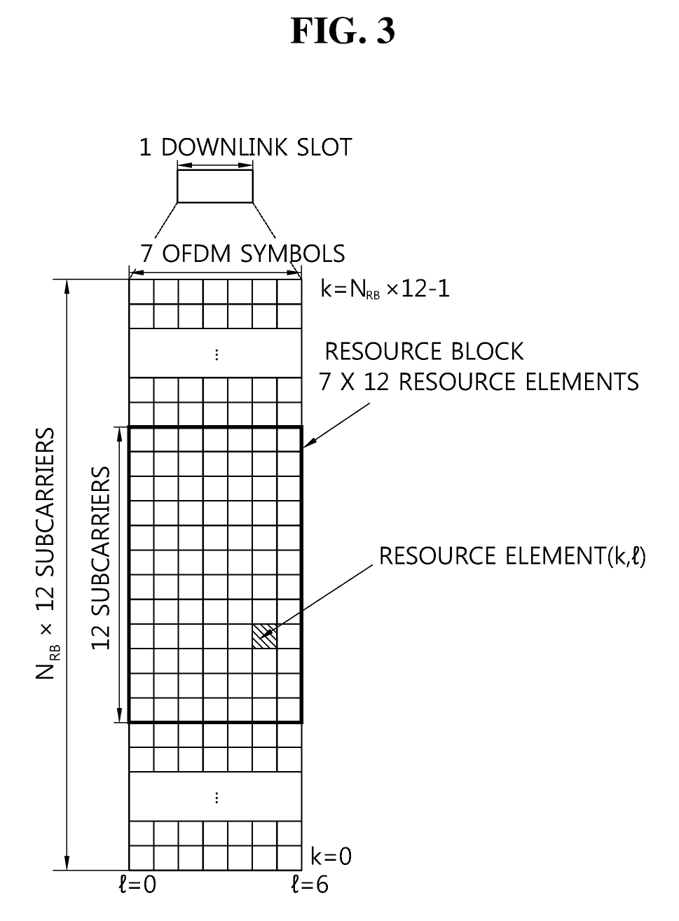

FIG. 3 illustrates an example resource grid for one uplink or downlink slot in 3GPP LTE.

Referring to FIG. 3, the uplink slot includes a plurality of orthogonal frequency division multiplexing (OFDM) symbols in the time domain and NRB resource blocks (RBs) in the frequency domain. For example, in the LTE system, the number of resource blocks (RBs), i.e., NRB, may be one from 6 to 110.

Here, by way of example, one resource block includes 7×12 resource elements that consist of seven OFDM symbols in the time domain and 12 sub-carriers in the frequency domain. However, the number of sub-carriers in the resource block and the number of OFDM symbols are not limited thereto. The number of OFDM symbols in the resource block or the number of sub-carriers may be changed variously. In other words, the number of OFDM symbols may be varied depending on the above-described length of CP. In particular, 3GPP LTE defines one slot as having seven OFDM symbols in the case of CP and six OFDM symbols in the case of extended CP.

OFDM symbol is to represent one symbol period, and depending on system, may also be denoted SC-FDMA symbol, OFDM symbol, or symbol period. The resource block is a unit of resource allocation and includes a plurality of sub-carriers in the frequency domain. The number of resource blocks included in the uplink slot, i.e., NUL, is dependent upon an uplink transmission bandwidth set in a cell. Each element on the resource grid is denoted resource element.

Meanwhile, the number of sub-carriers in one OFDM symbol may be one of 128, 256, 512, 1024, 1536, and 2048.

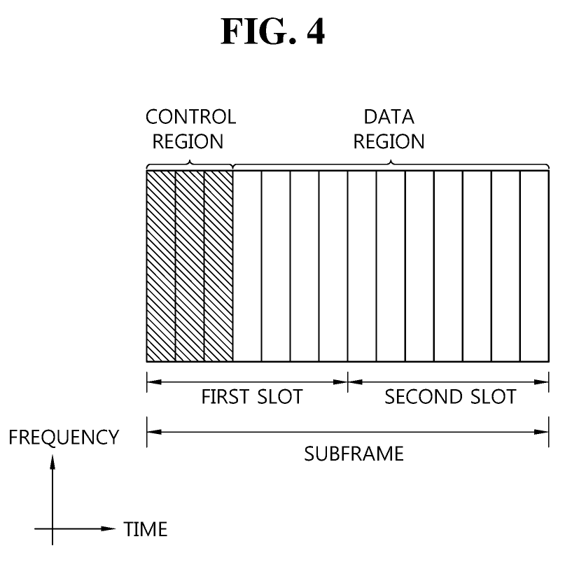

In 3GPP LTE, the resource grid for one uplink slot shown in FIG. 4 may also apply to the resource grid for the downlink slot.

FIG. 4 illustrates the architecture of a downlink sub-frame.

For this, 3GPP TS 36.211 V10.4.0 (2011-12) “Evolved Universal Terrestrial Radio Access (E-UTRA); Physical Channels and Modulation (Release 10)”, Ch. 4 may be referenced.

The radio frame includes 10 sub-frames indexed 0 to 9. One sub-frame includes two consecutive slots. Accordingly, the radio frame includes 20 slots. The time taken for one sub-frame to be transmitted is denoted transmission time interval (TI). For example, the length of one sub-frame may be 1 ms, and the length of one slot may be 0.5 ms.

One slot may include a plurality of orthogonal frequency division multiplexing (OFDM) symbols in the time domain. OFDM symbol is merely to represent one symbol period in the time domain since 3GPP LTE adopts orthogonal frequency division multiple access (OFDMA) for downlink (DL), and the multiple access scheme or name is not limited thereto. For example, the OFDM symbol may be referred to as single carrier-frequency division multiple access (SC-FDMA) symbol or symbol period.

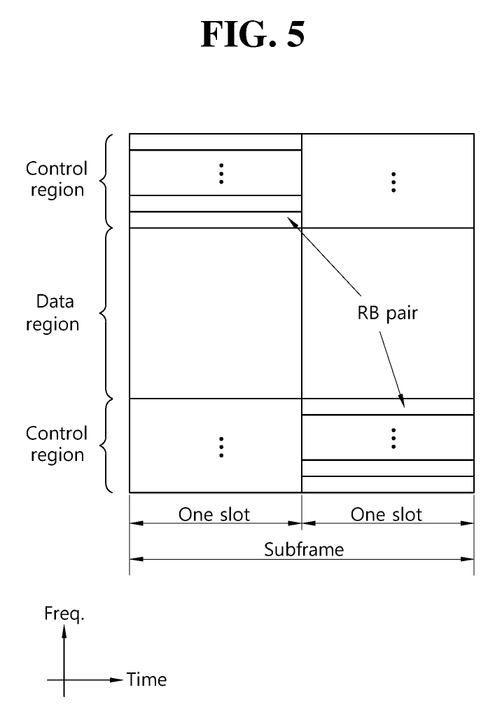

In FIG. 5, assuming the normal CP, one slot includes seven OFDM symbols, by way of example. However, the number of OFDM symbols included in one slot may vary depending on the length of cyclic prefix (CP). That is, as described above, according to 3GPP TS 36.211 V10.4.0, one slot includes seven OFDM symbols in the normal CP and six OFDM symbols in the extended CP.

Resource block (RB) is a unit for resource allocation and includes a plurality of sub-carriers in one slot. For example, if one slot includes seven OFDM symbols in the time domain and the resource block includes 12 sub-carriers in the frequency domain, one resource block may include 7×12 resource elements (REs).

The downlink (DL) sub-frame is split into a control region and a data region in the time domain. The control region includes up to first three OFDM symbols in the first slot of the sub-frame. However, the number of OFDM symbols included in the control region may be changed. A physical downlink control channel (PDCCH) and other control channels are assigned to the control region, and a PDSCH is assigned to the data region.

As set forth in 3GPP TS 36.211 V10.4.0, the physical channels in 3GPP LTE may be classified into data channels such as physical downlink shared channel (PDSCH) and physical uplink shared channel (PUSCH) and control channels such as physical downlink control channel (PDCCH), physical control format indicator channel (PCFICH), physical hybrid-ARQ indicator channel (PHICH), and physical uplink control channel (PUCCH).

The PCFICH transmitted in the first OFDM symbol of the sub-frame carries control format indicator (CIF) regarding the number (i.e., size of the control region) of OFDM symbols used for transmission of control channels in the sub-frame. The wireless device first receives the CIF on the PCFICH and then monitors the PDCCH.

Unlike the PDCCH, the PCFICH is transmitted through a fixed PCFICH resource in the sub-frame without using blind decoding.

The PHICH carries a positive-acknowledgement (ACK)/negative-acknowledgement (NACK) signal for a UL hybrid automatic repeat request (HARQ). The ACK/NACK signal for uplink (UL) data on the PUSCH transmitted by the wireless device is sent on the PHICH.

The physical broadcast channel (PBCH) is transmitted in the first four OFDM symbols in the second slot of the first sub-frame of the radio frame. The PBCH carries system information necessary for the wireless device to communicate with the base station, and the system information transmitted through the PBCH is denoted as a master information block (MIB). In comparison, system information transmitted on the PDSCH indicated by the PDCCH is denoted as a system information block (SIB).

The PDCCH may carry activation of voice over internet protocol (VoIP) and a set of transmission power control commands for individual UEs in some UE group, resource allocation of an upper layer control message such as a random access response transmitted on the PDSCH, system information on DL-SCH, paging information on PCH, resource allocation information of uplink shared channel (UL-SCH), and resource allocation and transmission format of downlink-shared channel (DL-SCH). A plurality of PDCCHs may be sent in the control region, and the terminal may monitor the plurality of PDCCHs. The PDCCH is transmitted on one control channel element (CCE) or aggregation of some consecutive CCEs. The CCE is a logical allocation unit used for providing a coding rate per radio channel's state to the PDCCH. The CCE corresponds to a plurality of resource element groups. Depending on the relationship between the number of CCEs and coding rates provided by the CCEs, the format of the PDCCH and the possible number of PDCCHs are determined.

The control information transmitted through the PDCCH is denoted downlink control information (DCI). The DCI may include resource allocation of PDSCH (this is also referred to as a downlink (DL) grant), resource allocation of PUSCH (this is also referred to as an uplink (UL) grant), a set of transmission power control commands for individual UEs in some UE group, and/or activation of Voice over Internet Protocol (VoIP).

The base station determines a PDCCH format according to the DCI to be sent to the terminal and adds a cyclic redundancy check (CRC) to control information. The CRC is masked with a unique identifier (radio network temporary identifier (RNTI)) depending on the owner or purpose of the PDCCH. In case the PDCCH is for a specific terminal, the terminal's unique identifier, such as cell-RNTI (C-RNTI), may be masked to the CRC. Or, if the PDCCH is for a paging message, a paging indicator, for example, paging-RNTI (P-RNTI) may be masked to the CRC. If the PDCCH is for a system information block (SIB), a system information identifier, system information-RNTI (SI-RNTI), may be masked to the CRC. In order to indicate a random access response that is a response to the terminal's transmission of a random access preamble, a random access-RNTI (RA-RNTI) may be masked to the CRC.

In 3GPP LTE, blind decoding is used for detecting a PDCCH. The blind decoding is a scheme of identifying whether a PDCCH is its own control channel by demasking a desired identifier to the cyclic redundancy check (CRC) of a received PDCCH (this is referred to as candidate PDCCH) and checking a CRC error. The base station determines a PDCCH format according to the DCI to be sent to the wireless device, then adds a CRC to the DCI, and masks a unique identifier (this is referred to as a radio network temporary identifier (RNTI)) to the CRC depending on the owner or purpose of the PDCCH.

According to 3GPP TS 36.211 V10.4.0, the uplink channels include a PUSCH, a PUCCH, a Sounding Reference Signal (SRS), and a physical random access channel (PRACH).

FIG. 5 illustrates the architecture of an uplink sub-frame in 3GPP LTE.

Referring to FIG. 5, the uplink sub-frame may be separated into a control region and a data region in the frequency domain. The control region is assigned a physical uplink control channel (PUCCH) for transmission of uplink control information. The data region is assigned a physical uplink shared channel (PUSCH) for transmission of data (in some cases, control information may also be transmitted).

The PUCCH for one terminal is assigned in resource block (RB) pair in the sub-frame. The resource blocks in the resource block pair take up different sub-carriers in each of the first and second slots. The frequency occupied by the resource blocks in the resource block pair assigned to the PUCCH is varied with respect to a slot boundary. This is referred to as the RB pair assigned to the PUCCH having been frequency-hopped at the slot boundary.

The terminal may obtain a frequency diversity gain by transmitting uplink control information through different sub-carriers over time. m is a location index that indicates a logical frequency domain location of a resource block pair assigned to the PUCCH in the sub-frame.

The uplink control information transmitted on the PUCCH includes a hybrid automatic repeat request (HARQ), an acknowledgement (ACK)/non-acknowledgement (NACK), a channel quality indicator (CQI) indicating a downlink channel state, and a scheduling request (SR) that is an uplink radio resource allocation request.

The PUSCH is mapped with a UL-SCH that is a transport channel. The uplink data transmitted on the PUSCH may be a transport block that is a data block for the UL-SCH transmitted for the ITI. The transport block may be user information. Or, the uplink data may be multiplexed data. The multiplexed data may be data obtained by multiplexing the transport block for the UL-SCH and control information. For example, the control information multiplexed with the data may include a CQI, a precoding matrix indicator (PMI), an HARQ, and a rank indicator (RI). Or, the uplink data may consist only of control information.

<Reference Signal>

Hereinafter, the reference signal will be described in detail.

A reference signal is generally transmitted as a sequence. A random sequence may be used for a reference signal sequence without any specific limitation. The reference signal sequence may use a Phase Shift Keying (PSK)-based computer generated sequence. Examples of the PSK may include Binary Phase Shift Keying (BPSK), Quadrature Phase Shift Keying (QPSK), and so on. Alternatively, the reference signal sequence may use a Constant Amplitude Zero Auto-Correlation (CAZAC) sequence. And, examples of the CAZAC sequence my include a Zadoff-Chu (ZC)-based sequence, a ZC sequence with cyclic extension, a ZC sequence with truncation, and so on. Alternatively, the reference signal sequence may use a pseudo-random (PN) sequence. Examples of the PN sequence may include an m-sequence, a computer generated sequence, a Gold sequence, a Kasami sequence, and so on. Furthermore, the reference signal sequence may use a cyclically shifted sequence.

The reference signal may be categorized as a cell-specific RS (CRS), a MBSFN reference signal (RS), and a user equipment (UE)-specific RS. The CRS corresponds to a reference signal that is transmitted to all UEs within a cell, and the CRS is used for channel estimation. The MBSFN reference signal may be transmitted from a subframe allocated for MBFSN transmission. The UE-specific RS corresponds to a reference signal that is received by a specific UE or a specific UE group. Herein, the UE-specific RS may also be referred to as a Dedicated RS (DRS). The DRS is mainly used by a specific UE or a specific UE group for data demodulation.

Hereinafter, a CRS will be described in detail.

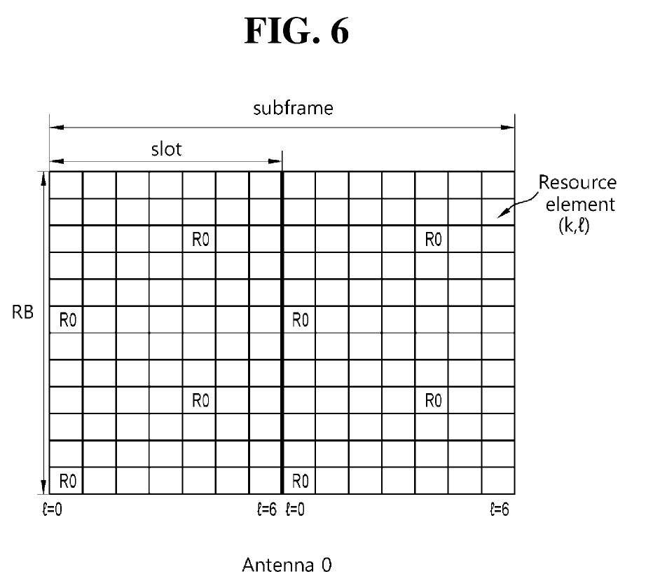

FIG. 6 to FIG. 8 respectively illustrate examples of Cell-specific Reference Signal (CRS) structures in case one or more antennas are used.

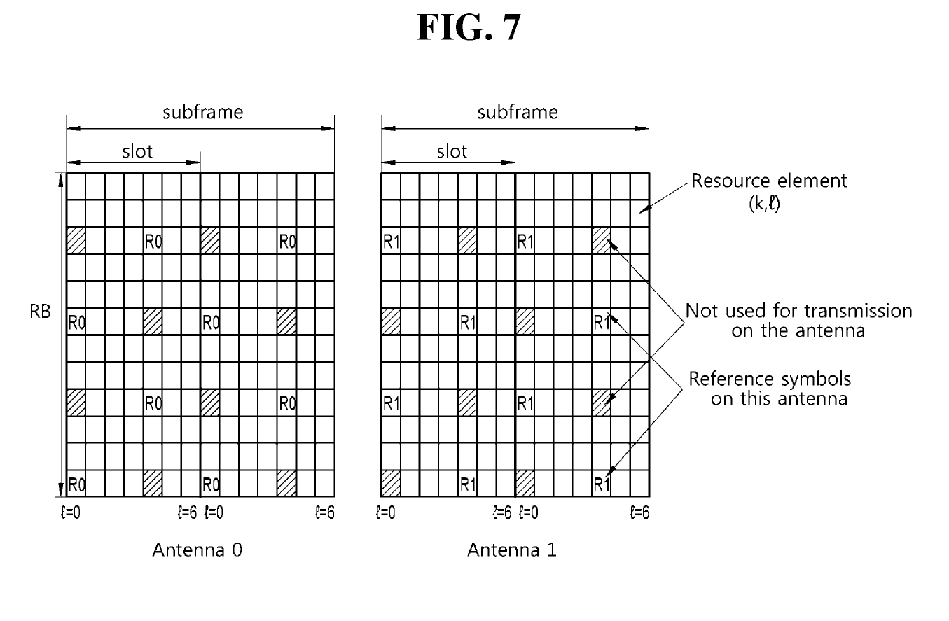

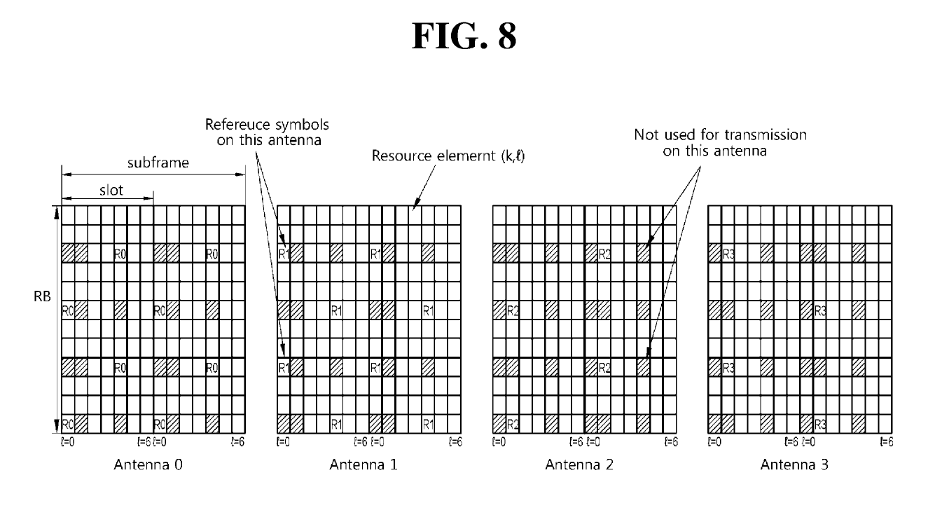

More specifically, FIG. 6 illustrates a CRS structure in a case where the base station uses one antenna, FIG. 7 illustrates a CRS structure in a case where the base station uses two antennas, and FIG. 8 illustrates a CRS structure in a case where the base station uses three antennas.

For the CRS structures shown in FIG. 6 to FIG. 8, reference may be made to Section 6.10.1 of 3GPP TS 36.211 V8.2.0 (2008-03). Also, the CRS structure may also be used for supporting a specific LTE-A system. For example, the CRS structure may be used for supporting the characteristics of Coordinated Multi-Point (CoMP) transmission/reception scheme or spatial multiplexing, and so on. Additionally, the CRS may also be used for the purposes of channel quality measurement, CP detection, time/frequency synchronization, and so on.

Referring to FIG. 6 to FIG. 8, in case of a multi-antenna transmission, wherein the base station uses multiple antennas, a resource grid exists for each antenna. ‘R0’ indicates a reference signal for a first antenna, ‘R1’ indicates a reference signal for a second antenna, ‘R2’ indicates a reference signal for a third antenna, and ‘R3’ indicates a reference signal for a fourth antenna. The positions of R0 to R3 within a subframe do not overlap with one another. C corresponds to a position of an OFDM symbol within a slot. And, in a normal CP, l is given a value ranging from 0 to 6. A reference signal for each antenna in one OFDM symbol is positioned at an interval of 6 subcarriers. In a subframe, a number of R0's and a number of R1's are equal to one another, and a number of R2's and a number of R3's are equal to one another. In the subframe, the number of R2's and the number of R3's are smaller than the number of R0's and the number of R1's. A resource element being used for the reference signal of one antenna is not used in the reference signal of another antenna. This is to avoid interference between the antennas.

Regardless of the number of streams, the number of CRSs that are transmitted always corresponds to the number of antennas. The CRS has an independent reference signal for each antenna. The position of the CRS in a frequency domain and the position of the CRS in a time domain in the subframe are determined regardless of the UE. The CRS sequence that is multiplied by the CRS is also generated regardless of the UE. Therefore, all of the UEs existing in the cell may receive a CRS. However, the position of a CRS within the subframe and the CRS sequence may be determined in accordance with a cell ID. The position of the CRS in the time domain of the subframe may be determined in accordance with the antenna number, and the number of OFDM symbols within the resource block. And, the position of the CRS in the frequency domain of the subframe may be determined in accordance with the antenna number, a cell ID, an OFDM symbol index (C), a slot number in a radio frame, and so on.

A CRS sequence may be applied in OFDM symbol units within a subframe. The CRS sequence may vary in accordance with a cell ID, a slot number in a radio frame, an OFDM symbol index in a slot, a CP type, and so on. A number of reference signal subcarriers for each antenna within an OFDM symbol is equal to 2. When a subframe is said to include N₉ number of resource blocks in the frequency domain, the number of reference signal subcarriers for each antenna within an OFDM symbol is equal to 2×NB. Accordingly, the length of a CRS sequence is equal to 2×NB.

Equation 1 shows an example of a CRS sequence r(m).

r(m)==1/\sqrt{2}(1−2·c(2m))+j1/\sqrt{2}(1−2·c(2m+1)) [Equation 1]

Herein, m is equal to 0, 1, . . . , 2N_{RB}^{max}−1. 2N_{RB}^{max} represents a number of resource blocks corresponding to a maximum bandwidth. For example, in a 3GPP LTE system, 2N_{RB}^{max} is equal to 110. c(i) represents a PN sequence corresponding to a pseudo-random sequence, which may be defined by a length-31 Gold sequence. Equation 2 shows an example of a Gold sequence c(n).

c(n)=(x₁(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2 [Equation 2]

Herein, Nc=1600, and x₁(i) represents a first m-sequence, and x₂(i) represents a second m-sequence. For example, the first m-sequence or the second m-sequence may be processed within initialization (or may be initialized) for each OFDM symbol in accordance with a cell ID, a slot number in a radio frame, an OFDM symbol index in a slot, a CP type, and so on.

In case of a system having a bandwidth that is smaller than 2N_{RB}^{max}, only a predetermined portion having a length of 2×N_{RB} is selected from a reference signal sequence that is generated to have a length of 2×2N_{RB}^{max} and used.

In an LTE-A system, the CRS may be used for the estimation of Channel State Information (CSI). In case the CRS is required for the estimation of the CSI, a Channel Quality Indicator (CQI), a Precoding Matrix Indicator (PMI), a Rank Indicator (RI), and so one may be reported from the UE.

Hereinafter, a DRS will be described in detail.

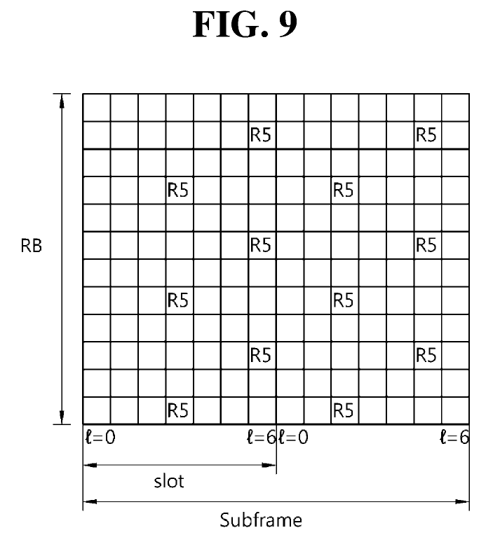

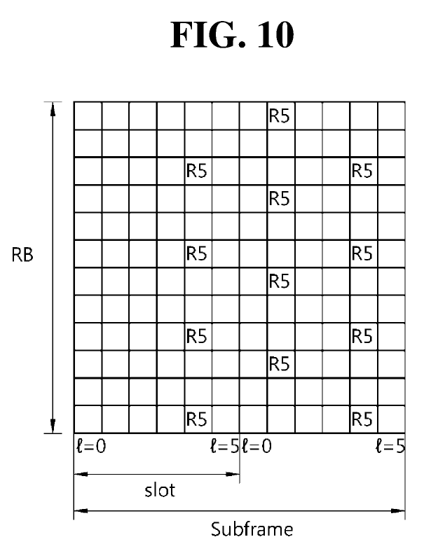

FIG. 9 and FIG. 10 respectively illustrate examples of Dedicated RS (DRS) structures.

FIG. 9 illustrates an example of a DRS structure in a normal CP In a normal CP, a subframe includes 14 OFDM symbols. ‘R5’ indicates a reference signal of an antenna transmitting a DRS. In an OFDM symbol including a reference signal, reference signal subcarriers are positioned at an interval of 4 subcarriers. FIG. 10 illustrates an example of a DRS structure in an extended CP In an extended CP, a subframe includes 12 OFDM symbols. In an OFDM symbol, reference signal subcarriers are positioned at an interval of 3 subcarriers. For a more detailed description, reference may be made to Section 6.10.3 of 3GPP TS 36.211 V8.2.0 (2008-03).

The position of the DRS in a frequency domain and the position of the CRS in a time domain in the subframe may be determined in accordance with the resource block that is allocated for the PDSCH transmission. The DRS sequence may be determined in accordance with the UE ID, and only the UE corresponding to the UE ID may receive the DRS.

The DRS sequence may also be obtained by using Equation 1 and Equation 2. However, in this case, the value of m in Equation 1 is determined by N_{RB}^{PDSCH}. Herein, N_{RB}^{PDSCH} corresponds to a number of resource blocks for the bandwidth corresponding to the PDSCH transmission. The length of the DRS sequence may vary in accordance with the N_{RB}^{PDSCH}. More specifically, the length of the DRS sequence may vary in accordance with the data size being allocated to the UE. The first m-sequence (x₁(i)) or the second m-sequence (x₂(i)) of Equation 1 may be processed within initialization (or may be initialized) for each subframe in accordance with a cell ID, a position of a subframe in a radio frame, a UE ID, and so on.

The DRS sequence is generated for each subframe and may be applied in OFDM symbol units. Herein, it will be given that the number of reference signal subcarriers per resource block is equal to 12, and that the number of resource blocks is equal to N_{RB}^{PDSCH}, in a subframe. The total number of reference signal subcarriers is equal to 12×N_{RB}^{PDSCH}. And, accordingly, the length of the DRS sequence is equal to 12×N_{RB}^{PDSCH}. In case a DRS sequence is generated by using Equation 1, m is equal to 0, 1, . . . , 12N_{RB}^{PDSCH}−1. The DRS sequence is serially mapped to reference symbols. The DRS sequence is first mapped to the reference symbols of the subcarrier index in an OFDM symbol in an ascending order, and, then, the DRS sequence is mapped to the to the next OFDM symbol.

In an LTE-A system, the DRS may be used as a Demodulation Reference Signal (DMRS) for performing PDSCH demodulation. More specifically, the DMRS may be understood as a concept of the DRS of the LTE Rel-8 system, which is used for beamforming, being extended to multiple layers. The PDSCH and the DMRS may follow the same precoding operations. The DMRS may be transmitted only from a resource block or layer that is scheduled by the base station, and orthogonality is maintained between each layer.

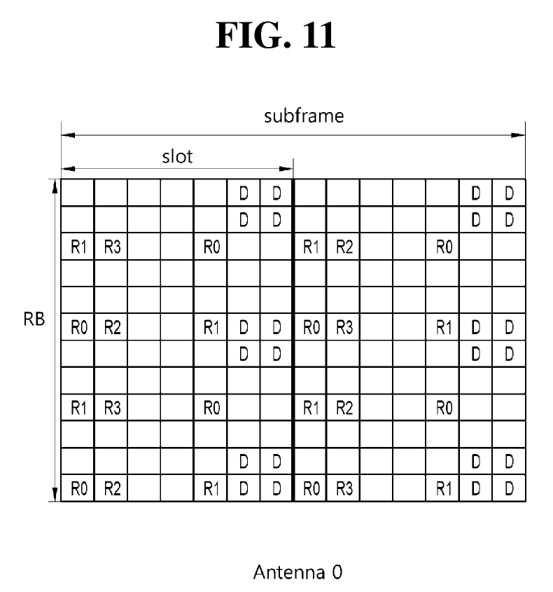

FIG. 11 illustrates an example of a DeModulation RS (DMRS) structure.

FIG. 11 illustrates a DMRS structure of an LTE-A system supporting 4 transmitting antennas in a normal CP structure. The same CRS of the LTE Rel-8 system may be used as a CSI-RS. The DMRS is transmitted from the last two OFDM symbols of each slot, i.e., the 6^{th}, 7^{th}, 13^{th}, and 14^{th} OFDM symbols. In the OFDM symbols from which the DMRS is transmitted, the DMRS is mapped to the 1^{st}, 2^{nd}, 6^{th}, 7^{th}, 11^{th}, and 12^{th} subcarriers.

Additionally, the CRS may be used at the same time as the DRS. For example, it will be assumed that control information is transmitted through 3 OFDM symbols (l=0, 1, and 2) of the first slot within the subframe. The OFDM symbol having OFDM symbol indexes of 0, 1, and 2 (l=0, 1, and 2) may use the CRS, and the remaining OFDM symbols excluding the 3 OFDM symbols may use the DRS. At this point, by multiplying a pre-defined sequence by downlink reference signals for each cell and by transmitting the processed sequence, interference of reference signals being received by the receiver from an adjacent (or neighboring) cell may be reduced, thereby enhancing the channel estimating performance. Herein, the pre-defined sequence may correspond to any one of a PN sequence, an m-sequence, a Walsh-Hadamard sequence, a ZC sequence, a GCL sequence, a CAZAC sequence, and so on. The pre-defined sequence may be applied in OFDM symbol units in a subframe. And, another sequence may be applied in accordance with a cell ID, a subframe number, a position of the OFDM symbol, a UE ID, and so on.

<Performance Estimation in a Dual Mobility Environment>

As described above, the demand for fast rate data communication in a dual mobility environment, such as an express train, is increasing. The performance estimation in a channel, which is received by a UE in the above-described dual mobility environment, will hereinafter be described in detail.

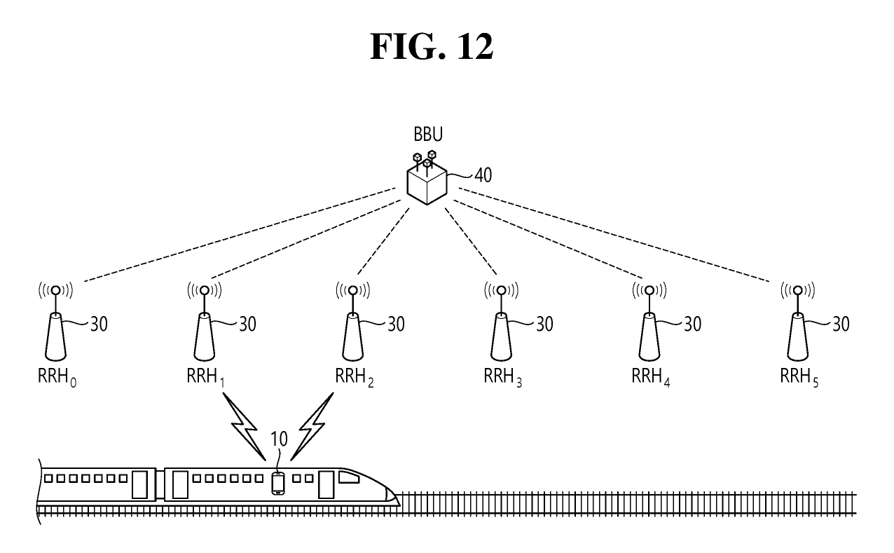

FIG. 12 illustrates an example of a dual mobility environment.

Referring to FIG. 12, in order to provide service to the user equipment (UE) 10 in a dual mobility environment, one or more Remote Radio Heads (RRHs) 30 may be configured in accordance with a travel path (e.g., railway (or railroad) track of the express train) of the UE 10. The one or more RRHs 30 provide service to the UE 10 through a Base Band Unit (BBU) 40. And, the UE 10 and the RRH 40 use an SFN channel. Herein, the RRH 30 corresponds to a device of the base station from which the radio frequency part is separated. And, the BBU 40 corresponds to a device of the base station from which the baseband part is separated.

The UE 10, which is positioned inside a means of transportation (e.g., express train), is connected to two RRHs (RRH₁ and RRH₂) via radio link. In this case, based on the UE 10, although the RRH₂ existing in a direction to which the UE 10 is intended to travel (or move) and the RRH₁ existing in a direction from which the UE 10 has traveled (or passed) are positioned at opposite directions from one another, their relative speed is the same. Therefore, the UE 10 receives a channel including a doppler frequency from each of the RRH₁ and the RRH₂. More specifically, the UE 10 receives a channel including two doppler frequencies each having signs opposite to one another from the RRH₁ and the RRH₂.

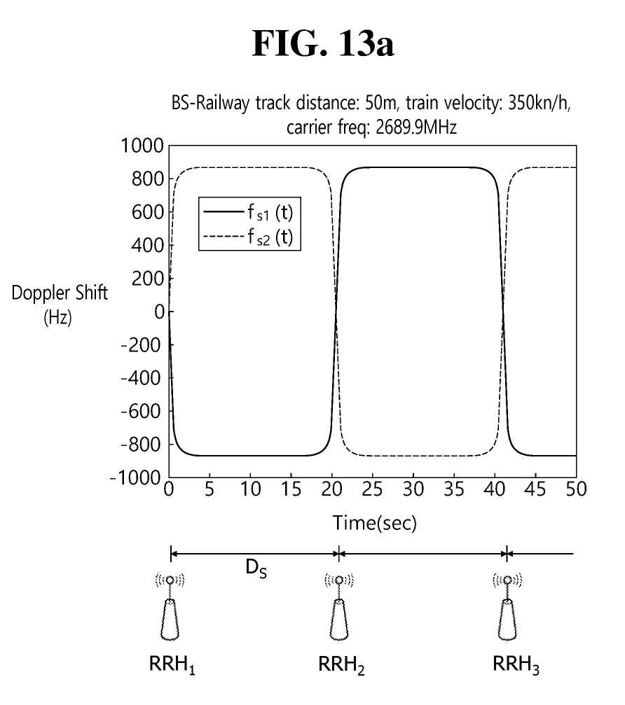

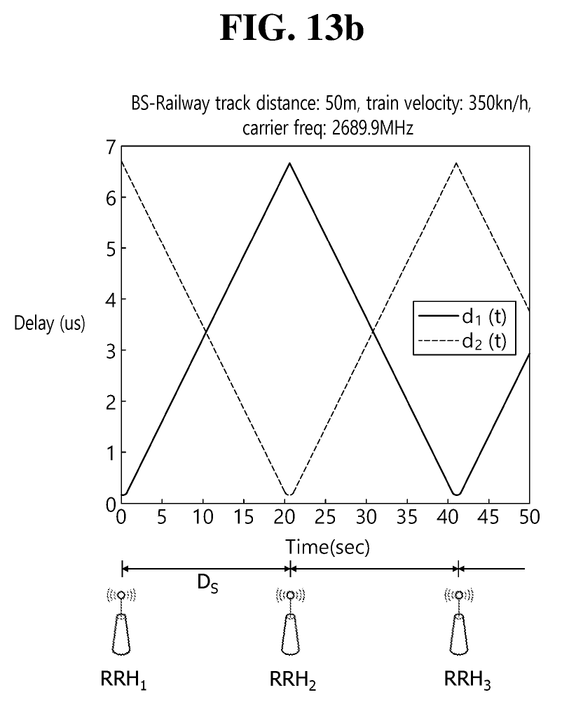

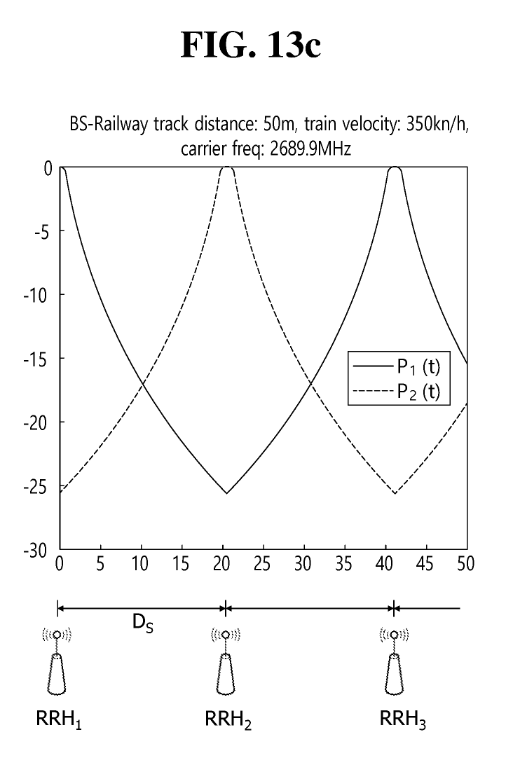

FIG. 13a to FIG. 13c respectively illustrate simulation results indicating channel characteristics of two Doppler frequencies.

FIG. 13a illustrates a doppler shift of signals received from each of the plurality of RRHs 30 being connected to the moving (or travelling) UE 10. FIG. 13b illustrates a distance between the moving UE 10 and each RRH 30. And, FIG. 13c illustrates the intensity of the signals received by the moving UE 10 from each RRH 30.

Meanwhile, the current LTE or LTE-A standard lacks the definition of a dual mobility environment Most particularly, the current LTE or LTE-A standard does not specifically define operations of a wireless device for two doppler frequencies. More specifically, in a dual mobility environment, a general wireless device performs frequency estimation by performing single frequency tracking. And, in a dual mobility environment, in order to allow the wireless device to perform dual frequency tracking, a channel estimator having a considerably high level of complexity is required.

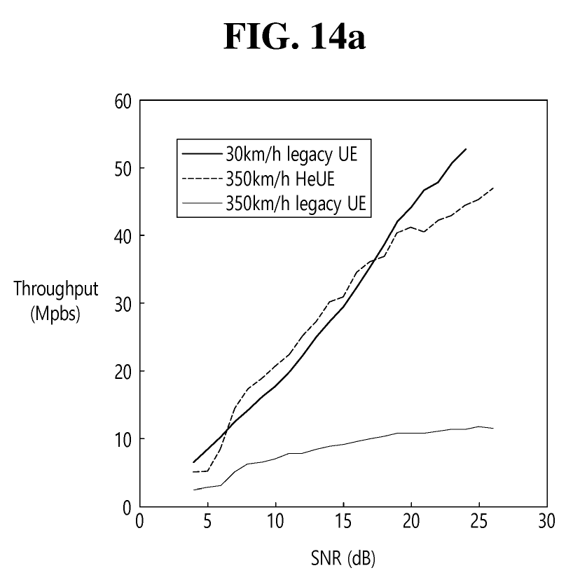

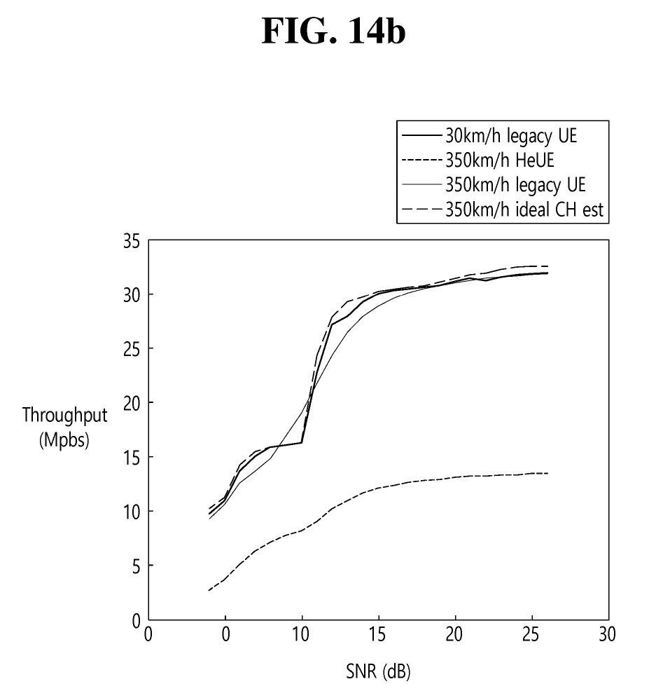

FIG. 14a and FIG. 14b respectively illustrate simulation results indicating channel estimating performance in a dual mobility environment.

FIG. 14a illustrates an adaptation performance of a wireless link in a dual mobility environment. And, FIG. 14b illustrates the performance of a Fixed Reference Channel (FRC) for the adaptation performance of the wireless device shown in FIG. 14a.

As shown in FIG. 14a and FIG. 14b, in case of the legacy wireless device performing single frequency tracking, if the travel speed increases, the channel estimating performance is degraded. In case of a High speed scenario enabled UE (HeUE), even if the travel speed increases, the channel estimating performance is not degraded. However, the level of complexity of the channel estimator increases excessively, thereby causing disadvantages, such as an increase in computation complexity and an increase in power consumption.

<Disclosure of this Specification>

In order to resolve the above-described problems, the exemplary embodiments of this specification propose solutions that can prevent performance degradation in an SFN channel and that can prevent an increase in complexity in channel estimation at the same time by performing dual frequency tracking.

1. Solution for Notifying Current Channel Environment as an SFN Channel Environment

First of all, in an SFN channel environment considering RRH 30 (i.e., a dual mobility environment), the base station 20 is required to notify the UE 10 that the current channel status is an SFN channel environment. In this case, the UE 10 that has recognized the current channel status as the SFN channel environment will perform the solutions proposed in this specification, which will hereinafter be described in detail. In the description presented below, the base station 20 will be conceptually described to include any one of the RRH 30 and the BBU 40 or both the RRH 30 and the BBU 40.

In order to notify the UE 10 that the current channel status corresponds to the SFN channel environment, the base station 20 may transmit a pre-arranged signal to the UE 10. In the following description, a signal for notifying the UE 10 that the current channel status corresponds to the SFN channel environment will be described as a DualFreqTrack.

At this point, the DualFreqTrack signal may correspond to a 1-bit information. For example, in case the value of the DualFreqTrack is equal to 1, this may indicate that the current channel environment corresponds to the SFN channel environment. And, in case the value of the DualFreqTrack is equal to 0, this may indicate that the current channel environment does not correspond to the SFN channel environment.

The base station 20 may transmit DualFreqTrack by performing the methods that are described below.

1) Transmission Through a System Information Block (SIB)

The base station 20 may transmit the DualFreqTrack by using an SIB, which is transmitted through a Physical Downlink Shared Channel (PDSCH). In this case, the UE 10 may not be capable of performing dual frequency estimation until the SIB is received through the PDSCH.

2) Transmission Through a Master Information Block (MIB)

The base station 20 may transmit the DualFreqTrack by using an MIB, which is transmitted through a Physical Broadcast Channel (PBCH). The MIB that is transmitted through the PBCH is configured of a total of 40 bits. However, only 30 bits are actually used for transmitting the MIB information, and the remaining 10 bits are configured as spare bits. Among 10 bits that are configured as the spare bits, 1 bit used for transmitting the DualFreqTrack. In this case, when only the PBCH is received, the UE 10 may immediately perform frequency tracking. Additionally, since the legacy UE is designed to disregard (or ignore) the 10 bits, which are configured as spare bits, in the aspect of signaling, backward compatibility is available. An example of a structure of an MIB including the DualFreqTrack is as shown below.

-- ASN1START

| | |
|---|---|
| MasterInformationBlock ::= | SEQUENCE { |

| | |
|---|---|
| d1-Bandwidth | ENUMERATED { |

n6, n15, n25, n50, n75, n100},

| | |
|---|---|
| phich-Config | PHICH-Config, |
| systemFrameNumber | BIT STRING (SIZE (8)), |

[symbol]

| | |
|---|---|
| DualFreqTrack | ENUMERATED { Disable, Enable } |
| spare | BIT STRING (SIZE (9)) |

}
-- ASN1STOP

2. Solution for Reducing Complexity in Dual Frequency Estimation

In order to reduce the complexity in the dual frequency estimation in the SFN channel environment (i.e., dual mobility environment), this specification proposes a method of performing channel estimation by dividing the reference signal into two groups.

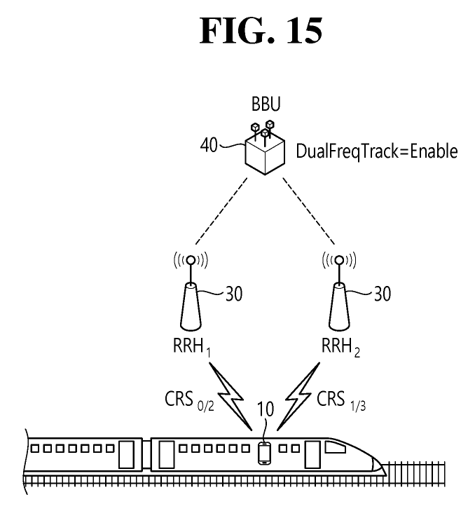

FIG. 15 conceptually illustrates a channel estimation method according to this specification.

More specifically, in order to reduce complexity in the dual frequency estimation, the base station 20 may transmit a CRS as described below.

1) A number of CRSs corresponding to the number of antennas are transmitted. And, the BBU 40 divides the CRSs into an odd-numbered group and an even-numbered group. For example, in case 4 antennas are used, the BBU 40 may divide the CRSs, which are to be transmitted, to one group consisting of CRS 0 and CRS 2 and another group consisting of CRS 1 and CRS 3. Herein, CRS 0 corresponds to a reference signal for a first antenna port, CRS 1 corresponds to a reference signal for a second antenna port, CRS 2 corresponds to a reference signal for a third antenna port, and CRS 3 corresponds to a reference signal for a fourth antenna port.

2) The BBU 40 allocates each of the divided odd-numbered group and even-numbered group to adjacent RRHs 30 each being different from one another. For example, the BBU 40 may allocate RRH₁ to the odd-numbered group and the RRH₂ to the even-numbered group.

3) After the pre-coding of the data, which are to be transmitted based on the CRS, is completed, the data may be transmitted through the respective RRH 30 being allocated with the corresponding antenna port.

Additionally, the UE 10 performs channel estimation as described below.

1) In case the DualFreqTrack is received, the UE 10 divides the received CRSs to an odd-numbered group and an even-numbered group. For example, in case 4 antennas are used, the UE 10 divides the received CRSs to one group consisting of CRS 0 and CRS 2 and another group consisting of CRS 1 and CRS 3.

2) The UE 10 estimates a dual doppler frequency for each of the divided groups. At this point, the doppler estimation for each group may be performed by using the legacy method. Additionally, it may be determined that the statistical characteristics of the odd-numbered group and the even-numbered group are the same.

3) Based on the dual doppler frequency estimated for each group, the UE 10 performs channel estimation by using channel estimation parameters, which are predetermined in advance for each group. At this point, the channel estimation parameters may be different for each group.

4) The UE 10 performs Automatic Frequency Control (AFC) based on a weighted-average value of a channel power weight for each group corresponding to the dual frequency tracking results, which are estimated for each group.

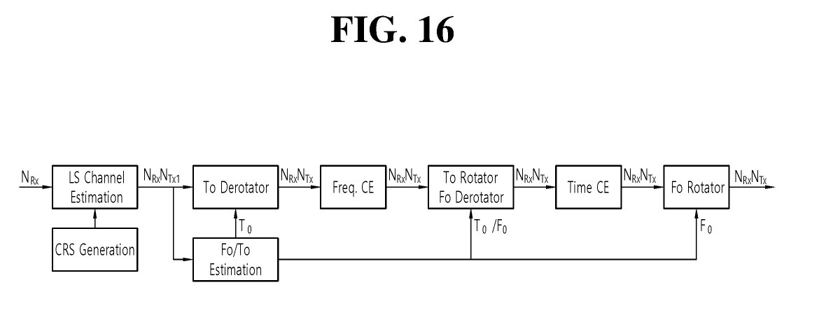

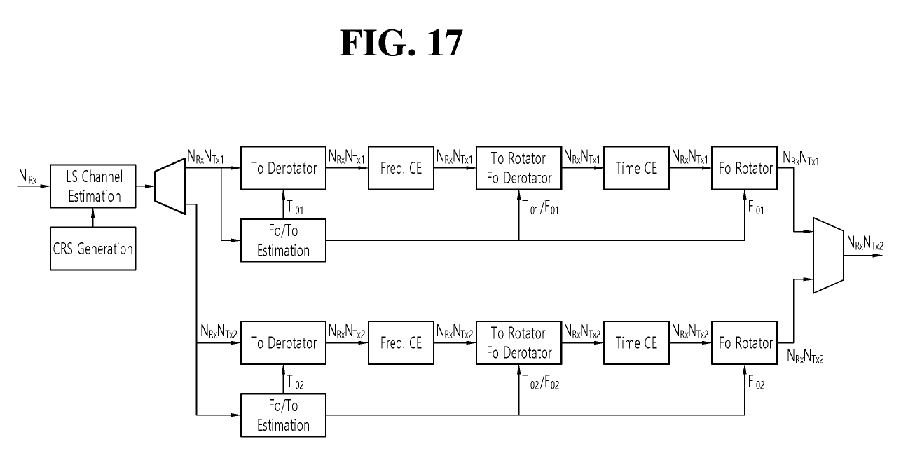

FIG. 16 illustrates an exemplary structure of a related art CRS channel estimator. And, FIG. 17 illustrates an exemplary structure of a CRS channel estimator according to this specification.

As described above, if channel estimation is performed by dividing the reference signal into two groups, the dual frequency estimation is distributed to two groups. More specifically, the CRS channel estimator according to this specification may be implemented by using only one additional doppler frequency tracker and path masking. The exemplary structures of the related art CRS channel estimator and the CRS channel estimator according to the present invention are shown in FIG. 16 and FIG. 17.

Therefore, according to this specification, channel estimation may be performed even in an environment where two doppler frequencies exist, while minimizing the complexity of the channel estimator.

Additionally, among the solutions proposed in this specification, only the solution of transmitting a DualFreqTrack signal is applied. And, even in a case where the solution of dividing the reference signal into two different groups is not applied, the solution proposed in the present invention may be applied by performing blind estimation after performing Least Squares (LS) channel estimation, thereby dividing channels into a plurality of channel groups.

Up to this section of the specification, the CRS-based transmission has been described. However, the solutions proposed in this specification may also be applied to the DMRS-based transmission. More specifically, the solutions proposed in this specification may be applied to the DMRS-based transmission as described below.

1) RRH Allocation Per Port

In case a single layer transmission is performed to the RRH 30, which is divided into an odd-numbered group and an even-numbered group, the transmission is performed by allocating each of Port 7 and Port 8 to one UE 10. In this case, only the single layer transmission is actually performed for the transmission of the resource elements (REs). Since it is expected to be highly unlikely that multiple links exist in the SFN channel environment, the above-described RRH allocation per port shall be possible.

2) RRH Allocation Per Symbol

In case the DMRS signal corresponds to Transmission Mode (TM) 7 based on the time axis, orthogonal covering is applied to the 3^{rd}, 6^{th}, 9^{th}, and 12^{th} OFDM symbols. And, in case the DMRS signal corresponds to TM 8/9/10, orthogonal covering is applied to the 6^{th}, 7^{th}, 12^{th}, and 13^{th} OFDM symbols. Thus, waste of resource elements may be limited, and the number of antenna ports may be increased. In case of sequence TM 8/9/10 for a normal CP, the orthogonal covering for the OFDM symbols are as shown below in the following table.

TABLE 1

| Antenna port p | [w̅ₚ(0) w̅ₚ(1) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | \|+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

Accordingly, in case of TM7, OFDM symbols 3 and 9 are grouped as one group, and OFDM symbols 6 and 12 are grouped as another group, and by allocating each group to a different RRH 30, the solution of this specification, which is described based on the CRS, may be applied. Additionally, in case of TM8/9/10, OFDM symbols 6 and 12 are grouped as one group, and OFDM symbols 7 and 14 are grouped as another group, and by allocating each group to a different RRH 30, transmission may be performed without causing any damage in the orthogonality. In this case, the compensation for the channel estimation may be performed through each doppler frequency, which is estimated from the CRS ports corresponding to the same group.

Furthermore, the operations of the base station for the DMRS-based transmission may be performed by using the same method as the CRS-based transmission.

According to the above-described solutions, by notifying the current channel status as an SFN channel environment and by limiting the port allocation of the base station, degradation in the channel estimating performance may be prevented while minimizing the increase in complexity of the channel estimator included in the UE 10 in the dual mobility environment.

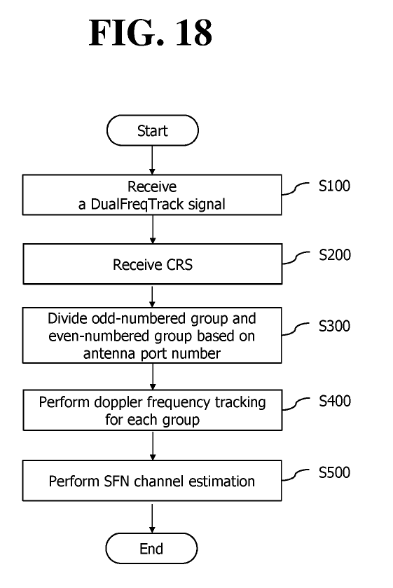

FIG. 18 is a flow chart showing a channel estimation method according to this specification.

Referring to FIG. 18, the UE 10 receives a signal for DualFreqTrack from the base station 20 (S100). Herein, the DualFreqTrack corresponds to an indicator for notifying that communication is being performed by using an SFN channel. The DualFreqTrack may be extracted from the MIB, which is received through the PBCH. Most particularly, the DualFreqTrack may be transmitted through the 1 bit, which was replaced for the transmission of the DualFreqTrack, among the spare bits (or reserved bits) included in the MIB.

The UE 10 receives two or more CRSs (S200). Then, the UE 10 divides the received two or more CRSs into two different groups based on the antenna port numbers (S300). At this point, only in the case where the signal for the DualFreqTrack has received, the UE 10 may divide the two or more CRSs into two different groups. More specifically, the UE 10 may divide the two or more CRSs into an odd-numbered group and an even-numbered group. The UE 10 may group the CRSs having odd-numbered antenna port numbers to the odd-numbered group and may group the CRSs having even-numbered antenna port numbers to the even-numbered group. As described above, the CRSs that are respectively divided to the odd-numbered group and the even-numbered group may be received through different RRHs 30.

For each of the divided groups, the UE 10 performs doppler frequency tracking (S400). And, based on the result of the doppler frequency tracking performed on each of the divided groups, the UE 10 performs SFN channel estimation (S500). Furthermore, based on a weighted-average value of the SFN channel estimation result, the UE 10 may also perform Automatic Frequency Control (AFC).

The embodiments of the present invention may be implemented through diverse means. For example, the embodiments of the present invention may be implemented in the form of hardware, firmware, and software, or a combination of two or more of the same.

In case of implementing the embodiments of the present invention in the form of hardware, the method according to the embodiments of the present invention may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro controllers, micro processors, and so on.

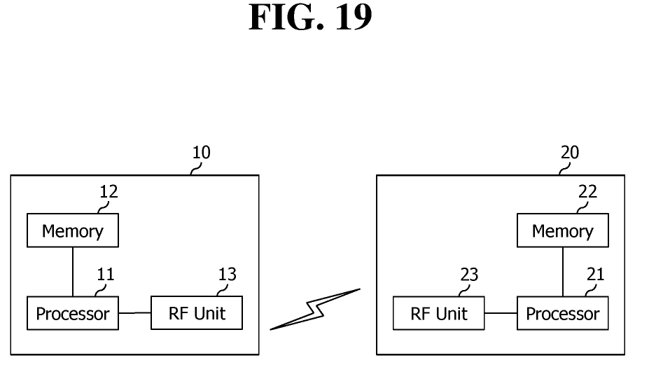

In case of implementing the embodiments of the present invention in the form of firmware or software, the method according to the embodiments of the present invention may be implemented in the form of a module, procedure, or function performing the above-described functions or operations. A software code may be stored in a memory unit and driven by a processor. Herein, the memory unit may be located inside or outside of the processor, and the memory unit may transmit and receive data to and from the processor by using a wide range of methods that have already been disclosed. This will be described in more detail with reference to FIG. 19.

FIG. 19 is a block diagram illustrating a wireless communication system according to an embodiment of the present invention.

A base station 20 includes a processor 21, a memory 22, and a radio frequency (RF) unit 23. The memory 22 is connected to the processor 21 to store various information for driving the processor 21. The RF unit 23 is connected to the processor 21 to transmit and/receive a wireless signal. The processor 21 implements a suggested function, procedure, and/or method. An operation of the base station 20 according to the above embodiment may be implemented by the processor 21.

A user equipment 10 includes a processor 11, a memory 12, and an RF unit 13. The memory 12 is connected to the processor 11 to store various information for driving the processor 11. The RF unit 13 is connected to the processor 11 to transmit and/receive a wireless signal. The processor 11 implements a suggested function, procedure, and/or method. An operation of the wireless 10 according to the above embodiment may be implemented by the processor 201.

A processor may include an application-specific integrated circuit (ASIC), another chipset, a logic circuit, and/or a data processor. A memory may include read-only memory (ROM), random access memory (RAM), a flash memory, a memory card, a storage medium, and/or other storage devices. An RF unit may include a baseband circuit to process an RF signal. When the embodiment is implemented, the above scheme may be implemented by a module (procedure, function, and the like) to perform the above function. The module is stored in the memory and may be implemented by the processor. The memory may be located inside or outside the processor, and may be connected to the processor through various known means.

In the above exemplary system, although methods are described based on a flowchart including a series of steps or blocks, the present invention is limited to an order of the steps. Some steps may be generated in the order different from or simultaneously with the above other steps. Further, it is well known to those skilled in the art that the steps included in the flowchart are not exclusive but include other steps or one or more steps in the flowchart may be eliminated without exerting an influence on a scope of the present invention.

1-14. (canceled)

15. A method for supporting a single frequency network (SFN), the method performed by a wireless device and comprising:
determining whether a flag indicating a high speed movement is received or not,
wherein the flag indicating the high speed movement is received for a SFN scenario; and
determining to control a transceiver to perform an operation for the SFN scenario if the flag indicating the high speed movement is received.

16. The method of claim 15, wherein the flag indicating the high speed movement is received via a system information block (SIB).

17. The method of claim 15, wherein for the SFN scenario, two or more Doppler shifts are observed in a high speed.

18. The method of claim 15, wherein the wireless device travels on a high speed train.

19. The method of claim 15, wherein the transceiver performs measurements.

20. The method of claim 15, wherein the SFN scenario includes radio a plurality of radio remotes heads (RRHs) which are distributed along with a railroad and uses a same frequency.

21. The method of claim 15, wherein the flag is expressed as one (1) bit.

22. The method of claim 15, wherein the operation includes:
receiving two or more cell-specific reference signals (CRSs);
classifying the two or more CRSs into two groups based on an antenna port number; and
performing a Doppler frequency tracking for each group; and
performing a channel estimation in the SFN scenario based on the Doppler frequency tracking.

23. The method of claim 22, wherein the classifying of the two or more CRSs into two groups includes:
identifying a first CRS transmitted by an antenna port indexed with an odd number; and
identifying a second CRS transmitted by an antenna port indexed with an even number.

24. The method of claim 23, wherein the first CRS by the antenna port indexed with the odd number is transmitted from a different RRH from the second CRS transmitted by the antenna port indexed with the even number.

25. A wireless device for supporting a single frequency network (SFN), the wireless device and comprising:
a transceiver;
a processor configured to control the transceiver and configured to:
determine whether a flag indicating a high speed movement is received or not,
wherein the flag indicating the high speed movement is received for a SFN scenario; and
determine to control the transceiver to perform an operation for the SFN scenario if the flag indicating the high speed movement is received.

26. The wireless device of claim 25, wherein the flag indicating the high speed movement is received via a system information block (SIB).

27. The wireless device of claim 25, wherein for the SFN scenario, two or more Doppler shifts are observed in a high speed.

28. The wireless device of claim 25, wherein the wireless device travels on a high speed train.

29. The wireless device of claim 25, wherein the transceiver performs measurements.

30. The wireless device of claim 25, wherein the SFN scenario includes radio a plurality of remotes heads (RRHs) which are distributed along with a railroad and uses a same frequency.
